(19) United States
(12) Patent Application Publication
(10) Pub. No.: US 2011/0158703 A1
(43) Pub. Date: Jun. 30, 2011

(54) DEVELOPING APPARATUS AND PROCESS CARTRIDGE

(75) Inventors: Masaaki Sato, Yokohama-shi (JP); Hideki Kakuta, Suntou-gun (JP); Yasunori Toriyama, Numazu-shi (JP)

(73) Assignee: CANON KABUSHIKI KAISHA, Tokyo (JP)

(21) Appl. No.: 12/950,727

(22) Filed: Nov. 19, 2010

(30) Foreign Application Priority Data
Dec. 25, 2009 (JP) 2009-294014

(51) Int. Cl. G03G 15/08

(52) U.S. Cl. 399/279

(57) ABSTRACT

A developing apparatus includes a developer bearing member, a supporting portion, an urging unit, and a movement regulating member. The developer bearing member rotates while bearing developer. The supporting portion rotatably and movably supports the developer bearing member and includes a recessed portion that is formed into a concave shape. The urging unit urges the developer bearing member in a predetermined direction of the rotational axis direction. The movement regulating member is fitted to an end of the developer bearing member and is movable together with the developer bearing member. The movement regulating member may move to a first position where movement in a perpendicular direction is regulated by coming into contact with a portion of the supporting portion and a second position that is a position apart from the first position and movable in the perpendicular direction without coming into contact with the portion of the supporting portion.

### BACKGROUND OF THE INVENTION

1. Field of the Invention

The present invention relates to a developing apparatus included in an image forming apparatus such as a copying machine and a printer that forms an image on a recording medium by adopting an electrophotography system and a process cartridge detachable from the image forming apparatus.

2. Description of the Related Art

Electrophotography includes reproducing an original document by light bounced directly from the original to produce an electrostatic latent image on a photoconductive member. The electrostatic latent image is made visible by development using a developer bearing member, such as a rotatable cylinder, to support and transport dry developer material to a position where it is attracted to the latent image by an electrostatic force. Developing apparatuses whose product life has been reached and process cartridges (hereinafter, referred to as “cartridges”) are separated by part and material for recycling. For example, a developer bearing member as a process unit is cleaned and inspected to be reused as a process unit or materials for recycling. Product designs considering improvement of disassembly properties of parts are demanded to simplify disassembly and the recycling process and to improve efficiency thereof.

Conventionally, for disassembly of a cartridge or removal of recycling target parts, as discussed in Japanese Patent Application Laid-Open No. 2008-33271, a container frame is cut or a supporting member is removed. Moreover, when a container frame is cut by laser, as discussed in Japanese Patent Application Laid-Open No. 2000-263550, high efficiency of disassembly and recycling process is realized by protecting the recycling target parts by a resin material hard to be cut by laser and configuring the surrounding thereof by a resin material easy to be cut by laser.

In the process cartridge discussed in Japanese Patent Application Laid-Open No. 2008-33271, when a photosensitive drum is removed from a bearing member of the photosensitive drum, the photosensitive drum can be removed from a cleaning frame after the bearing member is removed from the cleaning frame by loosening screws. In this case, if the photosensitive drum can be removed without removing the bearing member from the cleaning frame, the convenience for the user will be increased.

In a process cartridge discussed in Japanese Patent Application Laid-Open No. 2000-263550, there is a burden that reusable resin products must be cut by laser. In this case, if cutting by laser becomes unnecessary, the convenience for the user will be increased.

### SUMMARY OF THE INVENTION

The present invention is directed to a developing apparatus that further improves disassembly properties of the developing apparatus.

According to an embodiment, a developing apparatus includes a developer bearing member, a supporting portion, an urging unit, and a movement regulating member. The developer bearing member rotates while bearing developer. The supporting portion rotatably and movably supports the developer bearing member and includes a recessed portion that is formed into a concave shape. The urging unit urges the developer bearing member in a predetermined direction of the rotational axis direction. The movement regulating member is fitted to an end of the developer bearing member and is movable together with the developer bearing member. The movement regulating member may move to a first position where movement in a perpendicular direction is regulated by coming into contact with a portion of the supporting portion and a second position that is a position apart from the first position and movable in the perpendicular direction without coming into contact with the portion of the supporting portion.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the invention.

FIG. 1 is a sectional view illustrating a configuration of an image forming apparatus according to an exemplary embodiment of the present invention.

FIGS. 2A and 2B are a sectional view and the like illustrating a configuration of a cartridge.

FIGS. 3A and 3B are an exploded perspective view and the like illustrating a configuration of a developing unit from which an end member and a protection member are removed.

FIG. 4 is a sectional view illustrating a configuration of the developing unit.

FIGS. 5A and 5B are side views illustrating a configuration of a developing roller and a supporting member.

FIGS. 6A and 6B are side views illustrating a configuration of a developing roller and a developing blade.

FIGS. 7A and 7B are side views illustrating a configuration of a developing roller and a photosensitive drum.

FIGS. 8A and 8B are sectional views illustrating a removal process of a developing unit.

### DESCRIPTION OF THE EMBODIMENTS

Various exemplary embodiments, features, and aspects of the invention will be described in detail below with reference to the drawings.

Dimensions, materials, and shapes of components described in the exemplary embodiments and their relative positions are to be changed depending on a configuration of an apparatus to which the present invention is applied or various conditions if necessary and thus, if not specifically mentioned, the scope of the present invention is not limited only to such dimensions, materials, and shapes or relative positions.

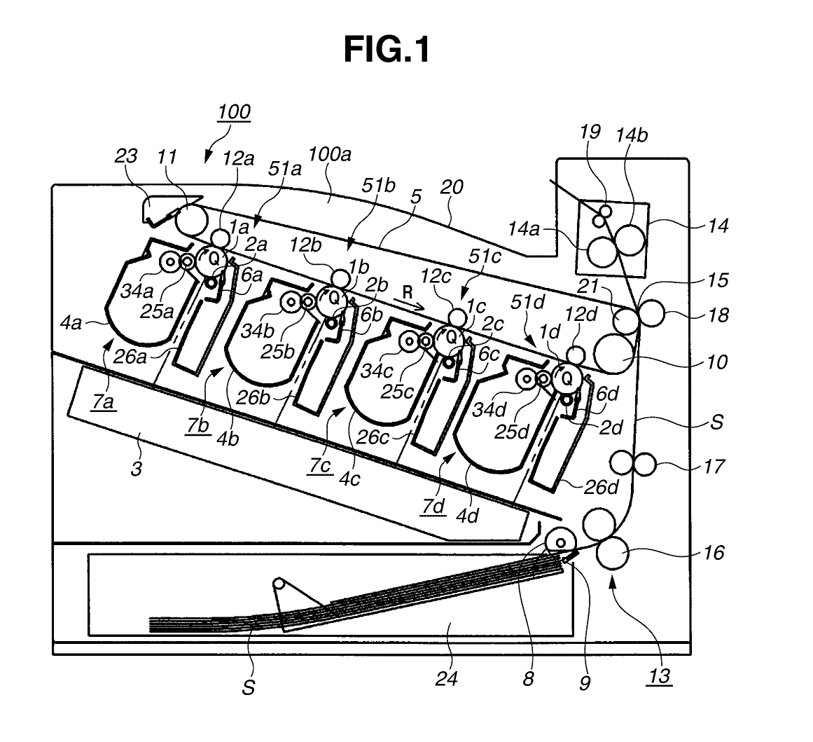

FIG. 1 is a sectional view illustrating a configuration of an image forming apparatus 100 according to an exemplary embodiment of the present invention. The image forming apparatus 100 is a color electrophotographic image forming apparatus using an electrophotographic image forming process. As illustrated in FIG. 1, the image forming apparatus 100 includes an image forming apparatus main body (hereinafter, referred to simply as an “apparatus main body”) 100a and image forming units 51a, 51b, 51c, and 51d to form an image are provided inside the apparatus main body 100a.

The image forming units 51a, 51b, 51c, and 51d includes electrophotographic photosensitive drums (hereinafter, simply referred to as “photosensitive drums”) 1a, 1b, 1c, and 1d which are “image bearing members” and primary transfer rollers 12a, 12b, 12c, and 12d which are “transfer devices”, respectively. At least the photosensitive drums 1a, 1b, 1c, and 1d are respectively included in process cartridges (hereinafter, referred to simply as “cartridges”) 7a, 7b, 7c, and 7d which are “developing apparatuses” and are incorporated into the apparatus main body 100a.

The four cartridges 7a, 7b, 7c, and 7d which are arranged in parallel with each other and inclined toward the horizontal direction can be mounted on the image forming apparatus 100. The mounted cartridges 7a to 7d include the photosensitive drums 1a, 1b, 1c, and 1d respectively.

The photosensitive drums 1a, 1b, 1c, and 1d are driven to rotate clockwise in FIG. 1 by a driving member (not illustrated). Around the photosensitive drums 1a, 1b, 1c, and 1d, below described process units which act on the photosensitive drums 1a, 1b, 1c, and 1d in turn according to a rotation direction thereof are arranged. More specifically, cleaning members 6a to 6d that remove developer (toner) remaining on a surface of the photosensitive drums 1a, 1b, 1c, and 1d after transfer and charging rollers 2a to 2d that uniformly charge the surface of the photosensitive drums 1a, 1b, 1c, and 1d are arranged. Further, developing units 4a to 4d which are developing apparatuses for developing an electrostatic image by toner are arranged.

Furthermore, a scanner unit 3 that forms an electrostatic image on the photosensitive drums 1a, 1b, 1c, and 1d by radiating laser beams based on image information and an intermediate transfer belt 5 to which toner images of four colors on the surface of the photosensitive drums 1a, 1b, 1c, and 1d are transferred together are arranged.

The photosensitive drums 1a, 1b, 1c, and 1d, the cleaning members 6a, 6b, 6c, and 6d, the charging rollers 2a, 2b, 2c, and 2d, and the developing units 4a, 4b, 4c, and 4d are integrally formed into cartridges to constitute the cartridges 7a, 7b, 7c, and 7d respectively. These cartridges 7a to 7d are removably mounted on the apparatus main body 100a of the image forming apparatus 100 by a user.

The intermediate transfer belt 5 is stretched on a driving roller 10, a tension roller 11, and a suspension roller 21. The primary transfer rollers 12a, 12b, 12c, and 12d are disposed inside the intermediate transfer belt 5 facing to the respective photosensitive drums 1a, 1b, 1c, and 1d. Then, a transfer bias is applied to the intermediate transfer belt 5 by a bias application unit (not illustrated).

Each of the photosensitive drums 1a, 1b, 1c, and 1d rotates in the direction of an arrow Q and the intermediate transfer belt 5 rotates in the direction of an arrow R. Toner images formed on the photosensitive drums 1a, 1b, 1c, and 1d are primarily transferred to the surface of the intermediate transfer belt 5 one after another by applying a positive bias to the primary transfer rollers 12a, 12b, 12c, and 12d. Then, the toner images of four colors superimposed on the intermediate transfer belt 5 are conveyed to a secondary transfer unit 15.

A sheet S, a recording medium, is conveyed by a conveyance unit composed of a feeding apparatus 13, a registration roller pair 17, and the like in synchronization with an image forming operation. The feeding apparatus 13 includes a feeding cassette 24 for storing the sheet S, a feeding roller 8 for feeding the sheet S, and a conveyance roller pair 16 for conveying the fed sheet S. The feeding cassette 24 can be pulled out in a forward direction of the apparatus main body 100a. The sheet S stored in the feeding cassette 24 is brought into press contact with the feeding roller 8, separated one sheet after another by a separation pad 9 (friction separation method), and conveyed.

Then, the sheet S conveyed from the feeding apparatus 13 is further conveyed to the secondary transfer unit 15 by the registration roller pair 17. In the secondary transfer unit 15, a positive bias is applied to a secondary transfer roller 18. Accordingly, the toner images of four colors on the intermediate transfer belt 5 are secondarily transferred to the conveyed sheet S.

A fixing unit 14 is used to fix the toner image formed on the sheet S by adding heat and pressure. A fixing belt 14a has a cylindrical shape and is guided by a belt guide member (not illustrated) to which a heating unit such as a heater is bonded. The fixing belt 14a and a pressure roller 14b form a fixing nip with a predetermined pressure contact force.

The sheet S on which an unfixed toner image conveyed from the image forming units is heated and pressurized by the fixing nip between the fixing belt 14a and the pressure roller 14b. Then, the unfixed toner image on the sheet S is fixed thereto. Subsequently, the sheet S onto which the toner image is fixed is discharged to a discharge tray 20 by a discharge roller pair 19.

On the other hand, toner remaining on the surface of the photosensitive drums 1a to 1d after the toner image being transferred is removed by the cleaning members 6a to 6d. The removed toner is recovered into removed toner chambers inside photosensitive units 26a to 26d.

Toner remaining on the intermediate transfer belt 5 is after the secondary transfer to the sheet S is removed by a transfer belt cleaning apparatus 23. The removed toner passes through a waste toner conveyance path (not illustrated) and is recovered into a waste toner recovery container (not illustrated) arranged on the back surface of the apparatus.

In a first exemplary embodiment, a configuration in which the intermediate transfer belt 5 is arranged facing to the photosensitive drums 1a to 1d and a toner image is transferred from the intermediate transfer belt 5 to the sheet S is exemplified, but the first exemplary embodiment is not limited to this configuration. More specifically, the first exemplary embodiment may have a configuration in which a sheet conveyance belt which is a recording medium conveyance body for conveying the sheet S is arranged facing to the photosensitive drums 1a to 1d and toner images are transferred from the photosensitive drums 1a to 1d to the sheet S.

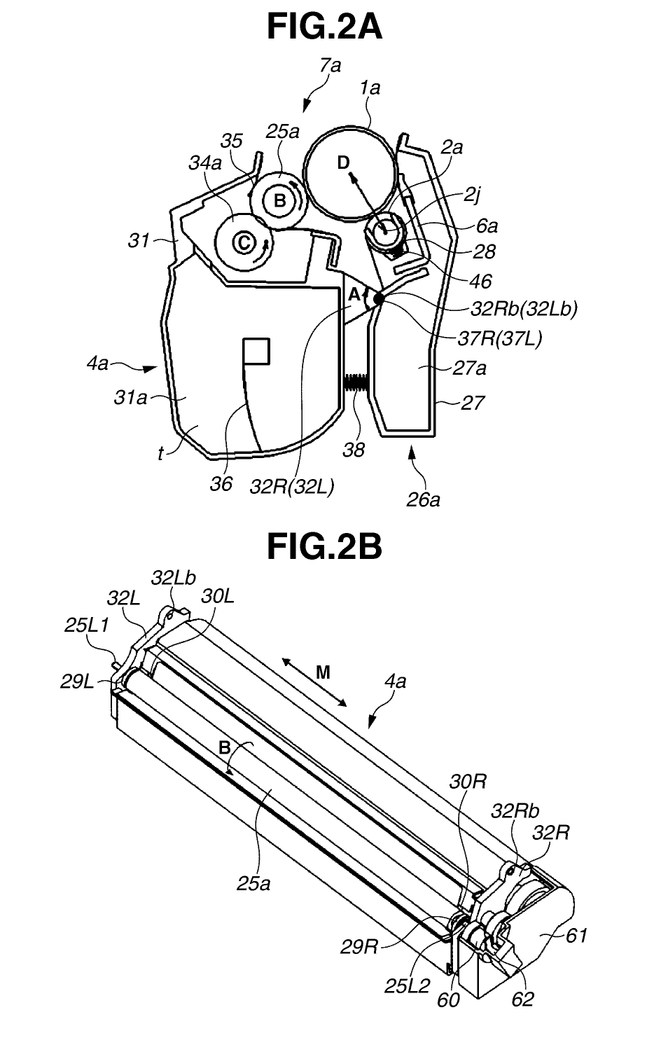

FIG. 2A is a sectional view illustrating a configuration of a cartridge 7a. The cartridge 7a contains toner t. The cartridge 7a containing the toner t in yellow, a cartridge 7b containing the toner t in magenta, a cartridge 7c containing the toner t in cyan, and a cartridge 7d containing the toner t in black have the same configuration. The cartridge 7a can be divided into the photosensitive unit 26a including the photosensitive drum 1a, the charging roller 2a as a charging unit, and the cleaning member 6a as a cleaning unit, and the developing unit 4a including a developing roller 25a as a developer bearing member which is a developing unit.

The photosensitive drum 1a is freely rotatably mounted on a cleaning frame 27 of the photosensitive unit 26a via a bearing (not illustrated). A driving force of a driving motor (not illustrated) is transmitted to the photosensitive unit 26a, and accordingly the photosensitive drum 1a is driven to rotate according to an image forming operation. As described above, the charging roller 2a and the cleaning member 6a are arranged on the circumference of the photosensitive drum 1a. Further, residual toner removed from the surface of the photosensitive drum 1a by the cleaning member 6a falls into a removed toner chamber 27a.

A charging roller bearing 28 is mounted on the cleaning frame 27 movably in the direction of an arrow D passing through the center of the charging roller 2a and that of the photosensitive drum 1a. An axis 2j of the charging roller 2a is rotatably mounted on the charging roller bearing 28. The charging roller bearing 28 is in a state where pressure is applied by a charging roller pressurizing member 46 toward the photosensitive drum 1a.

The developing unit 4a includes the developing roller 25a that rotates in the direction of an arrow B by being in contact with the photosensitive drum 1a and a development frame 31. The developing roller 25a is freely rotatably supported by the development frame 31 via supporting members (supporting portion) 32R and 32L provided on both sides in the longitudinal direction of the development frame 31. The developing roller is also supported movably in the rotational axis direction to the supporting members. Details of the support of the developing roller 25a by the supporting members 32R and 32L of the developing roller 25a will be described below.

Moreover, a toner feeding roller 34a that rotates in the direction of an arrow C by being in contact with the developing roller 25a and a developing blade 35 for regulating a toner layer on the developing roller 25a are arranged on the circumference of the developing roller 25a. Further, a toner conveyance member 36 for stirring contained toner and conveying the toner to the toner feeding roller 34a is provided in a toner storage unit 31a of the development frame 31.

The developing unit 4a is freely rotatably connected to the photosensitive unit 26a around axes 37R and 37L fitted into holes 32Rb and 32Lb provided, for example, in the supporting members 32R and 32L. The developing unit 4a is urged by a pressure spring 38 so that the developing roller 25a included in the developing unit 4a essentially is forced by the pressure spring 38 to abut on the photosensitive drum 1a included in the photosensitive unit 26a. When an image is formed by the cartridge 7a, the developing unit 4a rotates in the direction of an arrow A around the axes 37R and 37L, so that the developing roller 25a abuts on the photosensitive drum 1a.

FIG. 2B is a perspective view illustrating the configuration of the developing unit 4a. As illustrated in FIG. 2B, the developing unit 4a includes the supporting member 32R and the supporting member 32L. Both sides of the developing roller 25a are supported by the supporting member 32R and the supporting member 32L, and the developing roller 25a is freely rotatable while being supported by the supporting member 32R and the supporting member 32L. For example, a driving input member (not illustrated) is provided at one end 25L1, which is an “axis” of the developing roller 25a. The developing roller 25a rotates in the direction of an arrow B by receiving a rotation driving force from the driving input member of the developing roller 25a. An end member (movement regulating member) 60 is provided at the other end 25L2, which is an “axis” of the developing roller 25a, by engaging thereinto. Further, a protection member 61 is provided outside the end member 60 to cover the end member 60.

Spacers 29R and 29L are provided at both ends of the developing roller 25a and inside the supporting members 32R and 32L. When the developing roller 25a and the photosensitive drum 1a come into contact with each other, the spacers 29R and 29L at both ends of the developing roller 25a abut on the photosensitive drum 1a. Thus, a distance between the axis of the developing roller 25a and that of the photosensitive drum 1a is maintained constant.

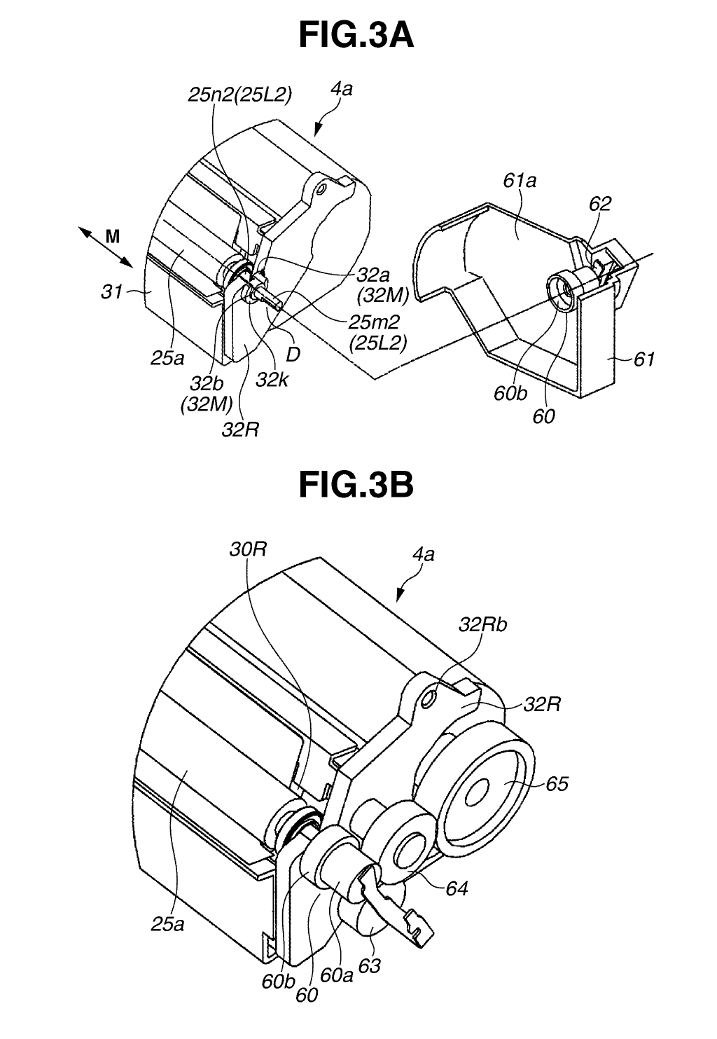

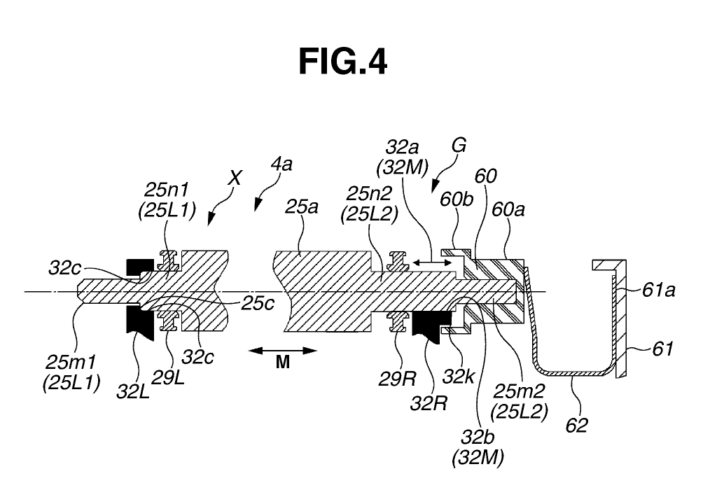

FIG. 3A is an exploded perspective view illustrating the configuration of the developing unit 4a from which the end member 60 and the protection member 61 are removed. Parts that are not involved in the connection of the developing roller 25a, the end member 60, and the protection member 61 are not illustrated to simplify the description. The developing roller 25a, which is a “developer bearing member” illustrated in FIG. 3A, bears a developer. In other words, developing roller 25a is a structural member that supports a developer material, such as a dry developer material to develop an electrostatic image, as a way of bearing that developer material. The developing roller 25a includes the one end 25L1 of the axis and the other end 25L2 of the axis (see FIG. 4). The one end 25L1 of the axis includes a one end-side minor diameter portion 25m1 whose diameter is small and a one end-side major diameter portion 25n1 whose diameter is large, and the one end-side minor diameter portion 25m1 is positioned on the outer side from the one end-side major diameter portion 25n1 (see FIG. 4). The other end 25L2 of the axis includes another end-side minor diameter portion 25m2 whose diameter is small and another end-side major diameter portion 25n2 whose diameter is large, and the other end-side minor diameter portion 25m2 is positioned on the outer side from the other end-side major diameter portion 25n2 (see FIG. 4).

On the other hand, the supporting member 32R includes a recessed portion (concave portion) 32M that is formed into a concave shape in the direction perpendicular to the axis of the developing roller 25a and supports the developing roller 25a freely rotatably inside the recessed portion 32M while the axis of the developing roller 25a is inserted into the recessed portion 32M. The recessed portion 32M includes an opening 32a through which the other end-side major diameter portion 25n2 is exposed and a sliding unit 32b that slides together with the other end-side major diameter portion 25n2 (see FIG. 4).

An engaging rib 32k is a “peripheral projecting portion (projecting portion)” projecting in a rotational axis direction M (more precisely, the axis direction M and the direction of the protection member 61) of the developing roller 25a. The engaging rib 32k is formed on the periphery of the recessed portion 32M of the supporting member 32R. The engaging rib 32k is a part of the supporting member 32R. The engaging rib 32k projects toward the outer side in the axis direction of the developing roller 25a to reinforce reception of the other end-side major diameter portion 25n2 which is the “axis” of the developing roller 25a. The above described recessed portion 32M is formed extending over the thickness of the supporting member 32R and the engaging rib 32k.

Regarding a relationship between the developing roller 25a and the supporting member 32R described above, a “regulation control unit” is present. The protection member 61, the end member (movement regulating member) 60, and an urging member (urging unit) 62 which form the “regulation control unit” are engaged with the engaging rib 32k of the supporting member 32R to regulate the developing roller 25a from being detached from the recessed portion 32M by pressing the developing roller 25a in the direction (predetermined direction) of the one end 25L1 of the axis of the developing roller 25a. Also, the protection member 61, the end member 60, and the urging member 62 which form the “regulation control unit” are disengaged from the engaging rib 32k of the supporting member 32R when the developing roller 25a is pressed in the direction of the other end 25L2 of the axis of the developing roller 25a (the opposite direction of the predetermined direction), and enables the developing roller 25a to be freely removed from the recessed portion 32M.

First, the protection member 61 includes a plate portion 61a mounted in the axis direction M of the developing roller 25a and on the outer side from the supporting member 32R to protect an inner side thereof. A part of the driving apparatus may be contained inside the protection member 61. In the present exemplary embodiment, various gears are arranged (see FIG. 3B).

The end member 60 includes a gear unit 60a and a flange unit 60b. The end member 60 engages with the other end-side minor diameter portion 25m2 of the other end 25L2, which is the “axis” of the developing roller 25a, and can freely move in the axis direction M of the developing roller 25a integrally therewith. The end member 60 moves to the direction toward the supporting member 32L, when viewed from the direction of the opening 32a of the recessed portion 32M, and takes a first position X overlapping with the supporting member 32R. If the end member 60 takes the first position X, the flange unit 60b of the end member 60 is engaged with the engaging rib 32k of the supporting member 32R.

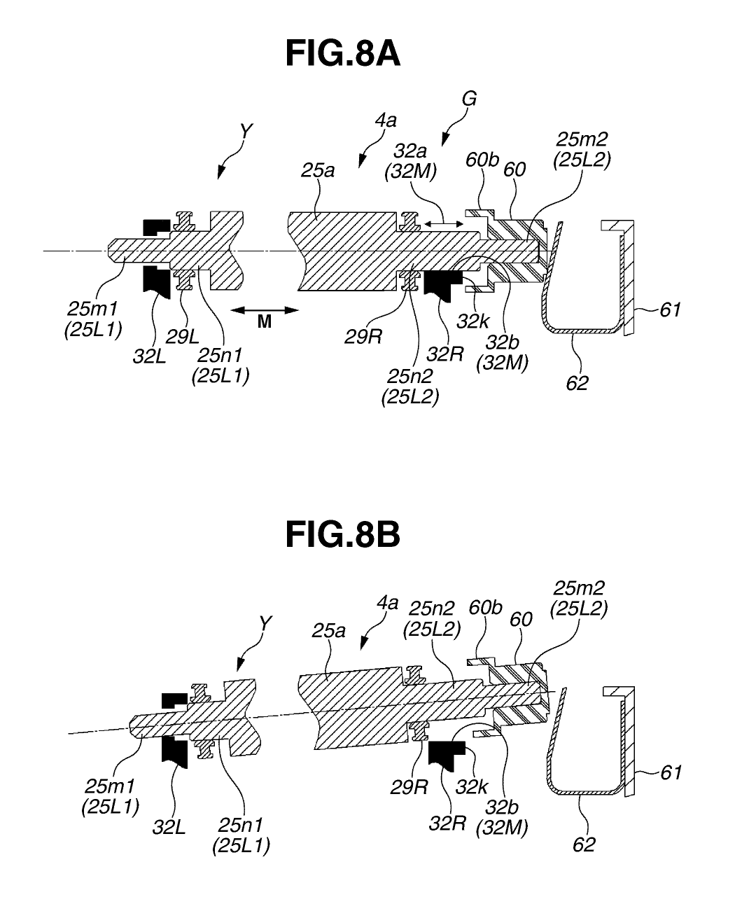

Further, the end member 60 also moves in the direction of the protection member 61, when viewed from the direction of the opening 32a of the recessed portion 32M, and takes a second position Y that does not overlap with the supporting member 32R. If the end member 60 takes the second position Y, the flange unit 60b of the end member 60 is disengaged from the engaging rib 32k of the supporting member 32R. See FIG. 4 for the state of the first position X and FIGS. 8A and 8B for the state of the second position Y.

The urging member 62 is mounted on an inner side surface of the plate portion 61a of the protection member 61 to urge the end member 60 toward the developing roller 25a by applying a force in a predetermined direction. The urging member 62 is always in contact with an end face of the end member 60 to urge the end member 60 in the direction of the developing roller 25a. Thus, the urging member 62 is provided between the end member 60 and the protection member 61.

The other end-side minor diameter portion 25m2 of the developing roller 25a and the end member 60 described below are connected by a phase determining shape such as a D cut. Further, as described above, the opening 32a is provided to the supporting member 32R which rotatably supports the developing roller 25a and thus, the other end 25L2 of the developing roller 25a is exposed so that the developing roller 25a can be removed from the supporting member 32R. The engaging rib 32k having a u-shape is provided near the supporting unit of the developing roller 25a of the supporting member 32R. On the other hand, the end member 60 has the flange unit 60b provided thereon. An outer diameter portion of the engaging rib 32k is equal to or smaller than an inner diameter portion of the flange unit 60b of the end member 60 and both are fitted. Details of the positional relationship between the supporting member 32R and the end member 60 will be described below.

FIG. 3B is a perspective view illustrating the configuration of the developing unit 4a from which the protection member 61 is removed. A toner feeding roller gear 63 that transmits driving to the toner feeding roller 34a and a toner conveyance gear 65 that transmits driving to the toner conveyance member 36 are provided at an end of the developing unit 4a. The end member 60 includes the gear unit 60a and the flange unit 60b. The gear unit 60a of the end member 60 constitutes a driving gear train together with the toner feeding roller gear 63, the toner conveyance gear 65, and an idler gear 64. Driving from a driving input source is transmitted from the gear unit 60a of the end member 60 to the toner feeding roller gear 63 or the toner conveyance gear 65 via the idler gear 64.

FIG. 4 is a sectional view illustrating the configuration of the developing unit 4a. Details of the positional relationship between the supporting member 32R and the end member 60 will be described. FIG. 4 is a sectional view of the developing unit 4a including peripheral components for connection and fitting of the developing roller 25a, the supporting member 32R, and the end member 60.

The developing roller 25a receives an urging force from the urging member 62 in the left direction in FIG. 4 together with the end member 60. The developing roller 25a has a step portion 25c formed between the one end-side minor diameter portion 25m1 and the one end-side major diameter portion 25n1. With the step portion 25c abutting on the supporting member 32L in the axis direction M (the step portion 25c coming into contact with a step portion 32c of the supporting member 32L), the developing roller 25a is positioned. The engaging rib 32k of the supporting member 32R and the flange unit 60b of the end member 60 are in a fitting relationship. FIG. 4 illustrates a case where the outer diameter portion of the engaging rib 32k is smaller than the inner diameter portion of the flange unit 60b of the end member 60 and a state of fitting with a gap.

Components in contact with the developing roller 25a include, seal members 30R and 30L (see FIGS. 2B and 3B) that prevent developer from flying out and leaking from the development frame 31 by regulating the developer inside the development frame 31, the developing blade 35 for regulating a toner layer on the developing roller 25a, and further the toner feeding roller 34a that feeds the developer to the developing roller 25a, the photosensitive drum 1a, the end member 60 and a gear train thereof that transmit driving to the toner feeding roller 34a. The directions of forces received by the developing roller 25a while driving (during an image formation operation) and resting will be described below one by one for each component using drawings.

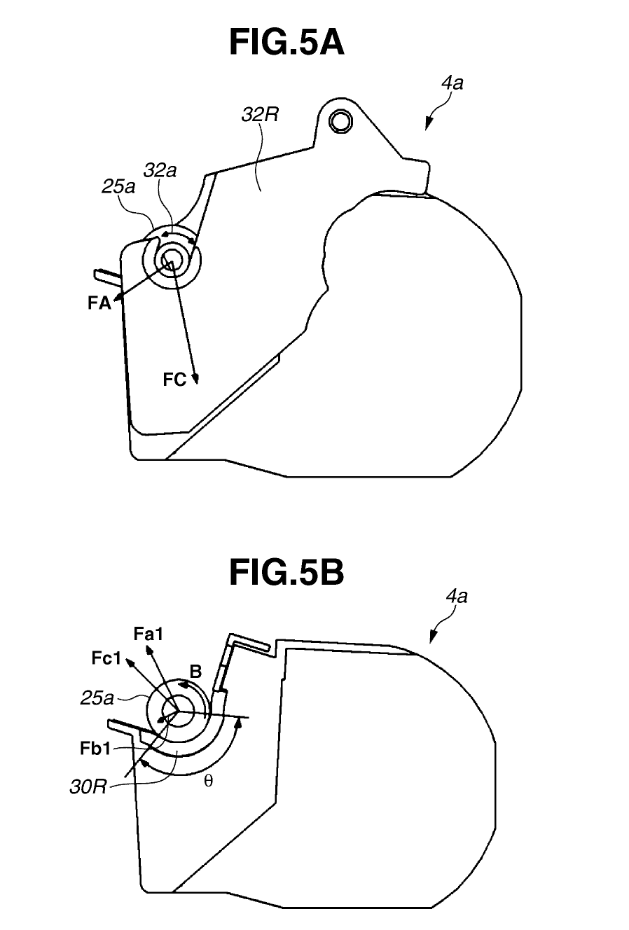

FIG. 5A is a side view illustrating the configuration of the developing roller 25a and the supporting member 32R. In the supporting member 32R, the opening 32a is formed to allow the developing roller 25a to be removed. The supporting member 32R positions the developing roller 25a based on the relation of forces acting on the developing roller 25a described below and rotatably supports the developing roller 25a.

FIG. 5B is a side view illustrating the configuration of the developing roller 25a and the seal member 30R. As illustrated in FIG. 5B, the developing roller 25a is in contact with the seal member 30R. The seal member 30R is in contact with the developing roller 25a within a fixed phase range θ of the outer circumference of the developing roller 25a. The seal member 30R is in contact with the developing roller 25a with predetermined pressure to prevent, as described above, the developer from flying out and leaking from the frame by regulating the developer inside the development frame 31. Through the contact with the seal member 30R, the developing roller 25a receives a force in the direction of an arrow Fa1 (when resting). If the developing roller 25a rotates in the direction of an arrow B, the developing roller 25a receives a frictional force generated on a contact portion on the seal member 30R in the direction of an arrow Fb1. Thus, the developing roller 25a receives a force in the direction of an arrow Fc1 that is a resultant force of the frictional force and the force in the direction of the arrow Fa1 when resting.

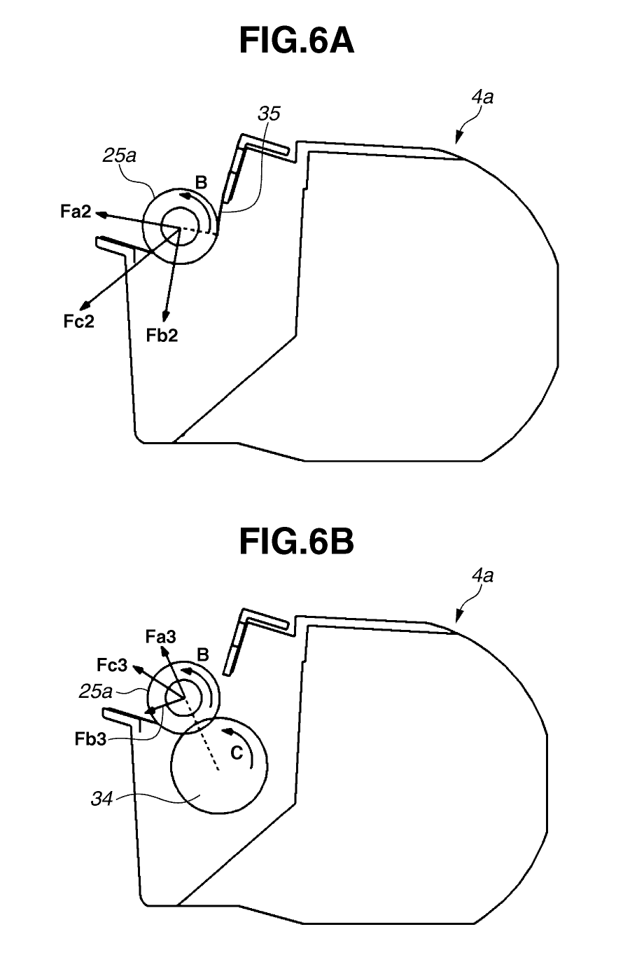

FIG. 6A is a side view illustrating the configuration of the developing roller 25a and the developing blade 35. As illustrated in FIG. 6A, the developing blade 35 is in contact with the developing roller 25a. To regulate a toner layer on the developing roller 25a, the developing blade 35 is in contact with the developing roller 25a with fixed pressure. Through the contact with the developing blade 35, the developing roller 25a receives a force in the direction of an arrow Fa2 (when resting). If the developing roller 25a rotates in the direction of the arrow B, the developing roller 25a receives a frictional force generated on a contact portion with the developing blade 35 in the direction of an arrow Fb2. Thus, the developing roller 25a receives a force in the direction of an arrow Fc2 as a resultant force of the frictional force and the force in the direction of the arrow Fa2 when resting.

FIG. 6B is a side view illustrating the configuration of the developing roller 25a and the toner feeding roller 34a. As illustrated in FIG. 6B, the toner feeding roller 34a is in contact with the developing roller 25a. To feed developer to the developing roller 25a, a surface layer of the toner feeding roller 34a is constituted of, for example, a urethane foam and configured to penetrate into the developing roller 25a by a fixed amount. Through the contact with the toner feeding roller 34a, the developing roller 25a receives a force in the direction of an arrow Fa3 (when resting).

The developing roller 25a rotates in the direction of the arrow B or the toner feeding roller 34a rotates in the direction of an arrow C. Then, the developing roller 25a receives a frictional force generated in a contact portion with the toner feeding roller 34a in the direction of an arrow Fb3. Thus the developing roller 25a receives a force in the direction of an arrow Fc3 as a resultant force of the frictional force and the force in the direction of the arrow Fa3 when resting.

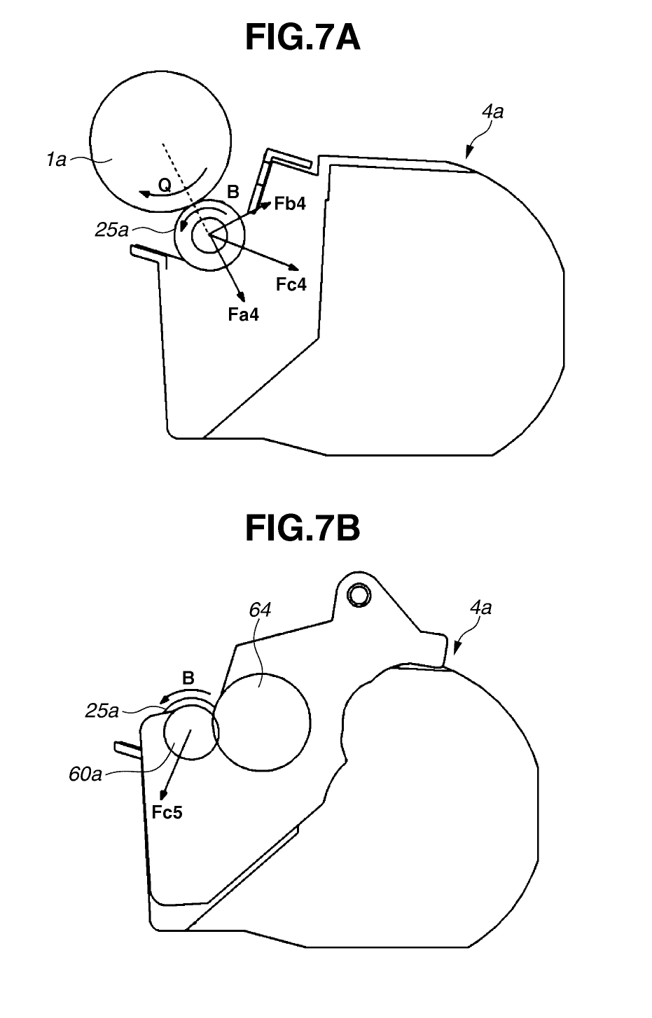

FIG. 7A is a side view illustrating the configuration of the developing roller 25a and the photosensitive drum 1a. As illustrated in FIG. 7A, the photosensitive drum 1a is in contact with the developing roller 25a. Through the contact with the photosensitive drum 1a, the developing roller 25a receives a force in the direction of an arrow Fa4 (when resting).

The developing roller 25a rotates in the direction of the arrow B or the photosensitive drum 1a rotates in the direction of an arrow Q. Then, the developing roller 25a receives a frictional force generated in a contact portion with the photosensitive drum 1a in the direction of an arrow Fb4, and receives a force in the direction of an arrow Fc, as a resultant force of the frictional force and the force in the direction of the arrow Fa4 when resting. The above description shows a case where a speed of the developing roller 25a on the surface layer is faster than that of the photosensitive drum 1a on the surface layer. If the speed of the developing roller 25a on the surface layer is slower than that of the photosensitive drum 1a on the surface layer, the arrow Fb4 is reversed to the opposite direction.

In general, when a latent image on the photosensitive drum 1a is developed, a contact development method in which the developing roller 25a and the photosensitive drum 1a are in contact with each other and a non-contact development method in which the developing roller 25a and the photosensitive drum 1a are separated from each other for development are known. In the above description, the contact development method is taken as an example. In the non-contact development method, for example, an amount of separation between the developing roller 25a and the photosensitive drum 1a is regulated by bringing spacers 29R and 29L (see FIGS. 2B and 3B) provided at both ends of the developing roller 25a into contact with the photosensitive drum 1a with fixed pressure. Also in this case, the spacers 29R and 29L come into contact with the photosensitive drum 1a as an alternative to the developing roller 25a in FIG. 7A and thus, like the above case, the developing roller 25a including the spacers 29R and 29L receives a force in the direction of each arrow.

FIG. 7B is a side view illustrating the configuration of the developing roller 25a and the idler gear 64. As illustrated in FIG. 7B, the idler gear 64 is in contact with the gear unit 60a of the end member 60 provided at an end of the developing roller 25a by engaging therewith. When driving is transmitted from the gear unit 60a of the end member 60 to the idler gear 64, the end member 60 receives a force in the direction of an arrow Fc5 which is a pressure angle direction of a tooth plane of the idler gear 64, from the tooth plane of the idler gear 64.

The directions of forces that the developing roller 25a receives from the above components in contact with the developing roller 25a, that is, the seal member 30R, the developing blade 35, the toner feeding roller 34a, the photosensitive drum 1a, the end member 60, and the gear train thereof have each been described when the developing roller 25a rests and rotates. As illustrated in FIG. 5A, the resultant force of such a plurality of forces is in the direction of an arrow FA if the force is received while resting and in the direction of an arrow FC if the force received while driving. More specifically, though the supporting member 32R includes the opening 32a to enable the removal of the developing roller 25a, the developing roller 25a does not receive a force in the direction toward the opening 32a regardless of whether the developing roller 25a is resting or driven, so that the developing roller 25a will not be thrown out of the opening 32a.

On the other hand, an unexpected external force may act when the cartridge 7a is handled or transported (distributed). Such external forces will be described one by one below using drawings together with a method for removing the developing roller 25a.

Returning to FIG. 4, the description of the support configuration of the developing roller 25a will be supplemented. As described above, the developing roller 25a does not receive any force in the direction toward the opening 32a of the supporting member 32R (an upward force in FIG. 4) regardless of whether the developing roller 25a is resting or driven, so that the developing roller 25a will not be detached from the supporting members 32R and 32L.

When the developing apparatus is handled or transported (distributed), the developing roller 25a may receive a force in the direction to the opening 32a of the supporting member 32R. However, the engaging rib 32k of the supporting member 32R and the flange unit 60b of the end member 60 are in a fitting relationship and thus, the end member 60 cannot move upward in FIG. 6. More specifically, the developing roller 25a connected to the end member 60 is configured not to be detached from the supporting member 32R. At this time, the supporting member 32R and the end member 60 are overlapped with each other, when viewed from the direction of an arrow G, which is the direction perpendicular to the axis of the developing roller 25a and the direction of the opening 32a of the supporting member 32R.

FIG. 8A is a sectional view illustrating a removal process of the developing unit 4a. FIG. 8B is a sectional view illustrating the removal process of the developing unit 4a. A method for removing the developing roller 25a will be described below with reference to FIGS. 8A and 8B.

FIG. 8A illustrates the developing roller 25a and the end member 60 moved in the right direction in FIG. 8A from the state of the sectional view of the developing unit 4a in FIG. 4 against an urging force of the urging member 62. Normally, the end member 60 receives the urging force from the urging member 62, the engaging rib 32k of the supporting member 32R and the flange unit 60b of the end member 60 are in a fitting relationship, and the developing roller 25a is located at the first position X illustrated in FIG. 4.

If an intentional external force is applied to the developing roller 25a and the end member 60 against the urging force from the urging member 62, the engaging rib 32k of the supporting member 32R and the flange unit 60b of the end member 60 are no longer in a fitting relationship. Then, the developing roller 25a takes the second position Y illustrated in FIG. 8A. At this point, the supporting member 32R and the end member 60 are not overlapped with each other, when viewed from the direction of the arrow G, which is the direction perpendicular to the axis of the developing roller 25a and the direction to the opening 32a of the supporting member 32R. Also at this point, the developing roller 25a is movable integrally with the end member 60 in the direction to the opening 32a of the supporting member 32R. Then, as illustrated in FIG. 8B, the developing roller 25a and the end member 60 can integrally be removed from the supporting member 32R.

With a sequence of operations of the developing roller 25a and the end member 60 illustrated in FIGS. 4, 8A, and 8B described above, the developing roller 25a and the end member 60 can be easily removed integrally from the developing unit 4a.

According to the present invention, when the developing roller 25a is removed from the supporting member 32R, the supporting member 32R and the surrounding member (the protection member 61) do not have to be removed. With only the developing roller 25a being easily removed, simplification and higher efficiency of the process of disassembling and recycling the cartridge 7a are realized.

The exemplary embodiment described above has been described regarding the cartridge 7a which is a “developing apparatus”, but the present invention is not limited to the above exemplary embodiment. More specifically, the “developing apparatus” may be one fixed to the apparatus main body 100a, instead of a cartridge.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-294014 filed Dec. 25, 2009, which is hereby incorporated by reference herein in its entirety.

What is claimed is:

1. A developing apparatus, comprising:
a developer bearing member configured to rotate while bearing developer;
a supporting portion having a concave portion that is formed into a concave shape in a direction perpendicular to a rotational axis direction of the developer bearing member and configured to support the developer bearing member rotatably and movably in the rotational axis direction inside the concave portion;
an urging unit configured to urge the developer bearing member in a predetermined direction of the rotational axis direction; and
a movement regulating member fitted to an end of the developer bearing member is configured to be movable together with the developer bearing member, and is configured to be movable to a first position where movement in a perpendicular direction to the rotational axis direction is regulated by coming into contact with a portion of the supporting portion and a second position that is a position apart from the first position in a direction opposite to the predetermined direction and movable in the perpendicular direction without coming into contact with the portion of the supporting portion.

2. The developing apparatus according to claim 1, wherein the portion of the supporting portion is a projecting portion projecting in an opposite direction from a periphery of the recessed portion.

3. The developing apparatus according to claim 1, wherein an outer diameter of a portion of the developer bearing member that fits into the movement regulating member is smaller than an outer diameter of a portion of the developer bearing member supported by the supporting portion.

4. The developing apparatus according to claim 1, further comprising: a protection member arranged on an outer side from the supporting portion in the rotational axis direction and configured to cover an end portion of the developer bearing member,
wherein the urging unit is provided in the protection member.

5. A process cartridge detachable from an image forming apparatus main body, the process cartridge comprising:
an image bearing member on which an electrostatic image is formed;
a developer bearing member configured to rotate while supporting developer to develop the electrostatic image;
a supporting portion having a concave portion that is formed into a concave shape in a direction perpendicular to a rotational axis direction of the developer bearing member and configured to support the developer bearing member rotatably and movably in the rotational axis direction inside the concave portion;
an urging unit configured to urge the developer bearing member in a predetermined direction of the rotational axis direction; and
a movement regulating member fitted to an end of the developer bearing member is configured to be movable together with the developer bearing member, and is configured to be movable to a first position where movement in a perpendicular direction to the rotational axis direction is regulated by coming into contact with a portion of the supporting portion and a second position that is a position apart from the first position in a direction opposite to the predetermined direction and movable in the perpendicular direction without coming into contact with the portion of the supporting portion.

6. The process cartridge according to claim 5, wherein the portion of the supporting portion is a projecting portion projecting in an opposite direction from a periphery of the recessed portion.

7. The process cartridge according to claim 5, wherein an outer diameter of a portion of the developer bearing member that fits into the movement regulating member is smaller than an outer diameter of a portion of the developer bearing member supported by the supporting portion.

8. The process cartridge according to claim 5, further comprising: a protection member arranged on an outer side from the supporting portion in the rotational axis direction and configured to cover an end portion of the developer bearing member,
wherein the urging unit is provided in the protection member.
